(19) United States
(12) Patent Application Publication
(10) Pub. No.: US 2014/0278737 A1
(43) Pub. Date: Sep. 18, 2014

(54) PRESENTING CHARACTERISTICS OF CUSTOMER ACCOUNTS

(71) Applicant: SAP AG, Walldorf (DE)

(72) Inventors: Arne Manthey, Mannheim (DE); Carsten Heuer, Schriesheim (DE); Tobias Hoppe-Boeken, Wiesbaden (DE)

(21) Appl. No.: 13/799,118

(22) Filed: Mar. 13, 2013

(51) Int. Cl. G06Q 30/02

(52) U.S. Cl. CPC G06Q 30/0201
USPC 705/7.29

(57) ABSTRACT

In general, the subject matter described in this disclosure can be embodied in methods, systems, and program products. Multiple customer accounts for which to display a graph that illustrates differences between characteristics of the multiple customer accounts are identified. A display of the graph that illustrates the differences between the characteristics of the multiple customer accounts is presented. User input that interacts with the displayed graph to select the user interface elements for a subset of the multiple customers is received. The selected user interface elements are presented in a different manner than the indication for those of the multiple customers that have not been selected.

### TECHNICAL FIELD

This document generally relates to presenting characteristics of customer accounts.

### BACKGROUND

A customer relationship management (CRM) system can be used to manage an organization's interactions with customers. The CRM system can provide various views of customer-related data. For example, the CRM system can be used to manage data relating to sales, marketing, customer service, technical support, and other areas.

A tablet computer is a mobile computing device that often includes a touchscreen. A user of the tablet computer can provide touch input to the tablet computer using, for example, a finger or stylus. For example, the user can interact with various objects that may be presented on a display of the tablet computer, such as in a user interface of an application. A virtual keyboard can be used to provide character input to the tablet computer.

### SUMMARY

This document describes techniques, methods, systems, and other mechanisms for presenting characteristics of customer accounts.

As addition description to the embodiments described below, the present disclosure describes the following embodiments.

Embodiment 1 is a computer-implemented method. The method comprises identifying, by a computing system, multiple customer accounts for which to display a graph that illustrates differences between characteristics of the multiple customer accounts, wherein each of the multiple customer accounts is associated with a first value for a first characteristic of the multiple customer accounts and a second value for a second characteristic of the multiple customer accounts. The method comprises presenting, by the computing system, a display of the graph that illustrates the differences between the characteristics of the multiple customer accounts, the displayed graph including multiple user interface elements that represent the multiple customer accounts and that are vertically positioned on the graph in accordance with the first values, and that are horizontally positioned on the graph in accordance with the second values. The method comprises receiving, by the computing system, user input that interacts with the displayed graph to select the user interface elements for a subset of the multiple customers. The method comprises presenting, by the computing system, the selected user interface elements in a different manner than the indication for those of the multiple customers that have not been selected.

Embodiment 2 is the method of embodiment 1, wherein: presenting the display of the graph includes presenting the display of the graph on a touchscreen display; and receiving the user input that interacts with the displayed graph includes receiving an indication of user input that contacted portions of the graph at which the user interface elements for the subset of the multiple customers were displayed.

Embodiment 3 is the method of embodiment 1, further comprising: displaying, within the display of the graph that illustrates the differences between the characteristics of the multiple customer accounts, one or more visual features that visually separate the multiple user interface elements that represent the multiple customer accounts into quadrants.

Embodiment 4 is the method of embodiment 3, wherein the one or more visual features identify a mean value for the first values for the multiple customer accounts and a mean value for the second values for the multiple customer accounts.

Embodiment 5 is the method of embodiment 3, wherein receiving the user input that interacts with the displayed graph includes receiving user input that interacts with the one or more visual features to select one of the quadrants, selection of the quadrant resulting in the computing system selecting each of the multiple user interface elements that are displayed as being within the one of the quadrants without user selection of any of the multiple user interface elements within the one of the quadrants individually.

Embodiment 6 is the method of embodiment 1, wherein each of the multiple customer accounts is associated with multiple first values for multiple respective times, and is associated with multiple second values for the multiple respective times; and further comprising receiving, by the computing system, user input that selects an interface element to change a selected time of the multiple times from a first time to a second time, and as a result causing a positioning of each of the multiple user interface elements to change from a positioning associated with the first value and the second value for the first time to the first value and the second value for the second time.

Embodiment 7 is the method of embodiment 1, further comprising: receiving, by the computing system, a first type of user input that contacts a portion of the display of the graph at which one of the multiple user interface elements is being displayed, and as a result adding a display of information that is associated with the customer account that is associated with the one of the multiple user interface elements to appear in a first style of presentation; and receiving, by the computing system, a second type of user input that contacts a portion of the display of the graph at which the one of the multiple user interface elements is being displayed, and as a result adding a display of only a subset of the information that is associated with the customer account that is associated with the one of the multiple user interface elements to appear in a second style of presentation.

Embodiment 8 is the method of embodiment 1, further comprising: identifying, by the computing system, at least two of the multiple customer accounts for which the first value for the first characteristic and the second value for the second characteristic for each of the at least two of the multiple customer accounts are similar in value; and presenting, by the computing system, a single one of the multiple user interface elements to represent the combination of the at least two of the multiple customer accounts.

Embodiment 9 is the method of embodiment 8, further comprising: receiving, by the computing system, user input that selects the presented single one of the multiple user interface elements, and as a result adding a concurrent display of information for each of the at least two of the multiple customer accounts. Embodiment 10 is the method of embodiment 8, wherein: each of the at least two of the multiple customer accounts is associated with a third value for a third characteristic; and the presented single one of the multiple user interface elements includes an indication of the third value for the third characteristic for each of the at least two of the multiple customer accounts, such that a viewer of the presented display of the graph is able to identify the third value for each of the at least two of the multiple customer accounts by viewing only the presented single one of the multiple user interface elements.

Particular implementations can, in certain instances, realize one or more of the following advantages. A user is able to identify, by looking at a displayed graph, multiple characteristics of multiple user accounts. A user is able to determine differences, similarities, and relationships between multiple, different user accounts. A user can determine how multiple characteristics of multiple user accounts change over time.

The details of one or more implementations are set forth in the accompanying drawings and the description below. Other features, objects, and advantages will be apparent from the description and drawings, and from the claims.

### DESCRIPTION OF DRAWINGS

FIGS. 1 to 5 show diagrams of computing devices that are displaying information about customer accounts.

FIG. 6 shows a flowchart of a process for displaying customer account information.

FIG. 7 is a block diagram of computing devices that may be used to implement the systems and methods described in this document, as either a client or as a server or plurality of servers.

Like reference symbols in the various drawings indicate like elements.

### DETAILED DESCRIPTION

This document generally describes displaying information. In general, a user interface can include a graph that includes graphical user interface elements that represent different customer accounts. A vertical position of each graphical user interface element can represent a value for one characteristic of the customer account and a horizontal position of each graphical user interface element can represent a value for another characteristic of the customer account. In some examples, each graphical user interface element can have one of multiple pre-designated colors, where each color represents a value for yet another characteristic of the customer. As such, a user is able to identify, by simply looking at the displayed graph, multiple characteristics of multiple user accounts. Moreover, because the graphical user interface elements for multiple user accounts may be displayed concurrently, the user may be able to determine differences and relationships between different user accounts (e.g., those user accounts with similar characteristics).

The customer account information may be stored by a Customer Relationship Management (CRM) system or an Enterprise Resource Planning (ERP) system, and the user interface may be provided by a device that communicates over a network with the CRM or ERP system, such as a mobile computing device (e.g., a tablet computer, laptop, or smartphone). The graph may include graphical user interface elements for accounts in a group assigned by a user of the CRM or ERP system. The group may have been assigned by the user, another user, or a computing system. For example, there may be hundreds of user accounts, and the user may have designated fifty of the accounts as belonging to a certain group, and may provide user input to cause the mobile computing device to display a graph with user interface elements that represent the fifty accounts.

In some examples, each customer account is associated with a single user interface element (e.g., a circle) on the display. The vertical or “x” axis may be associated with a particular characteristic, and the horizontal or “y” axis may be associated with another characteristic. Example characteristics include “discount,” “discount percentage,” “gross sales,” “lifetime sales,” “margin,” “margin percentage,” “production cost,” and “sales.” The display may include user interface elements with which the user can change the characteristic that is assigned to each axis, and thus the positioning of the user interface element for each customer account on the display.

The display may be a touchscreen display and a user may select individual ones of the customer account user interface elements by selecting portions of the display at which the customer account user interface elements are displayed. Customer account user interface elements that have been selected may be displayed in a first style (e.g., as a solid-colored circle) and customer account user interface elements that have not been selected may be displayed in a second style (e.g., as a circle with two colors, one color in the middle of the circle and one color at the periphery of the circle). Multiple customer account user interface elements may be displayed in a selected state at a given time.

The display may also include one or more visual features that separate the customer account user interface elements into quadrants. In some examples, the one or more visual features may be lines that intersect at a right angle. The default position of the lines, as displayed by the computing device without the computing device having received user input moving the position of the lines, may identify mean values for the customer accounts. For example, a horizontal line may be vertically positioned in the display so that the line represents a mean of the customer account values for the vertical axis characteristic. A vertical line may be horizontally positioned in the display so that the line represents a mean of the customer account values for the horizontal axis characteristic.

A user may provide input to move the horizontal and vertical lines. For example, a user may contact a touchscreen of the mobile computing device (e.g., with a finger of the user or a stylus) at a location at which an intersection of the horizontal and vertical lines are displayed, and then may move the contact. As a result, the computing device may cause the displayed location of the lines to move so that the displayed intersection of the lines would track the location of the user's finger. In this way, the user is able to change not only the displayed position of the horizontal and vertical lines, but also which customer account user interface elements fall into the quadrants specified by the lines.

The computing device may display a user interface element at an intersection of the horizontal and vertical lines, and this user interface element may include four portions designating the four respective quadrants. A user may select all of the customer account user interface elements in a quadrant by selecting the portion, of the user interface element at the intersection of the lines, that designates the quadrant that the user would like to select.

A customer account user interface element may be selected in multiple varying manners. A first type of user input (e.g., a tap of short duration) may be performed to include the user interface element in a group of selected user interface elements. The same first type of user input (e.g., another tap of short duration) may be performed to deselect the same user interface element. A second type of user input (e.g., a tap of long duration) may be used to view a summarized list of details regarding the customer account that is assigned to the user interface element in a pop-up window that appears in the graph at or near a displayed position of the customer account user interface element. The displayed location of the pop-up window may change depending on which user interface element was selected. A third type of user input (e.g., a double tap) may be used to view a more comprehensive list of details regarding the customer account that is assigned to the user interface element. The comprehensive list may be displayed in a sidebar to the side of the graph, or overlapping part of the graph. The displayed location of the sidebar may not change depending on which customer account user interface element was selected. In various implementations, different types of user inputs may be used to perform the above-described actions. Moreover, the different types of user input may be interchanged (e.g., a double tap may be used as the first type of user input and the tap of short duration may be used as the third type of user input).

Once a user has selected a group of multiple customer account user interface elements, for example, by tapping on the multiple customer account user interface elements or selecting one or more quadrants of customer account user interface elements, the user may save the group or send the group to another user. For example, the user may select a user interface element to save the group (and may provide user input to name the group), and the computing device or another computing system may store information that identifies that the customer accounts that are associated with the selected user interface elements are assigned to a same group to the exclusion of other user interface elements. Thus, at some later point in time, the user or another user may provide input requesting to view user interface elements that are assigned to the group. Moreover, the user may select a user interface element that, when selected, causes information that identifies the customer accounts that are assigned to the selected user interface elements to be emailed to another computing device.

In some implementations, the data that is stored for each customer account is time period specific. For example, “sales” data may represent sales-per-month, and the computing device may store sales data for a few dozen months. The computing device may include a user interface element with which a user of the computing device is able to change the time period that the data represents, and thus cause the displayed customer account user interface elements to move. For instance, the user interface element for changing the time period may be a slider, and the user may be able to select the slider and drag the slider to enact a change in the time period and cause the computing device to change the displayed location of the user interface elements.

In some implementations, the computing device does not display separate user interface elements for multiple customer accounts when the separate user interface elements would be displayed near each other (e.g., the user interface elements would at least partially overlap each other on the display). In some instances, the computing device may display a single user interface element for the multiple customer accounts. The single user interface element may include an indication (e.g., such as an number) that identifies how many user accounts are represented by the single user interface element.

As described previously, in some examples, the graph displays information regarding three characteristics of each customer account user interface element, and one of the three characteristics is represented by a color of the customer account user interface element. In such examples, the single user interface element that represents the group of multiple customer accounts may include separate portions of the single user interface element that are colored so as to represent the one of the three characteristics for each of the multiple customer accounts. For example, the single user interface element may include a circle with a number on the inside representing the quantity of customer accounts that are represented by the single user interface element, and around the number and at a periphery of the circle are slices of different color or patterns that represent the one of the three characteristics for each of the multiple customer accounts.

FIG. 1 shows a computing device 100. The computing device 100 can be, for example, a mobile computing device, such as a tablet computer. The computing device 100 can be another type of computing device, such as a desktop, laptop, smart phone, etc. In some implementations, the computing device 100 includes a touchscreen display.

The computing device 100 is presenting a relationship view user interface 102 which can be used by a user to view information about a group of customer accounts. The group of customer accounts can be selected by the user or can be automatically identified by the computing device 100 or another system. For example, a server can identify a group of customer accounts to which a particular sales representative user is assigned (e.g., as indicated by a title 103).

The computing device 100 or another computing system can identify a set of characteristics that apply to customer accounts. For example, some or all characteristics can be Key Performance Indicators (KPIs). For example, characteristics can include revenue, gross sales, margin, open due value, customer satisfaction, relationship activity, and profitability. Some characteristics, such as revenue, can be a numerical characteristic, and a particular customer account can have a numerical value (e.g., a corresponding amount of revenue) for the numerical characteristic.

As another example, some characteristics, such as customer satisfaction, can be an enumerated characteristic, and a particular customer account can have a value chosen from an enumerated list for the enumerated characteristic. For example, an enumerated list associated with the customer satisfaction characteristic can include values of very-satisfied, satisfied, neutral, unsatisfied, and very-unsatisfied. A value for the customer satisfaction characteristic for a particular customer account can be one of the values in the enumerated list for the characteristic, such as very-satisfied.

In some implementations, a numerical characteristic can be modeled as an enumerated characteristic. For example, a numerical customer satisfaction score that can have a value from 0 to 100 can be mapped to the enumerated customer satisfaction characteristic, with customer satisfaction scores of 0-19, 20-39, 40-59, 60-79, and 80-100 being mapped to values of very-unsatisfied, unsatisfied, neutral, satisfied, and very-satisfied, respectively.

As described in more detail below, the computing device 100 can present information (e.g., characteristic values) and relationships corresponding to customer accounts in the relationship view user interface 102. Other user interfaces can also be presented. For example, the computing device 100 can present a map view user interface which displays information for customer accounts on a map in response to receiving user input selecting a map view user interface element 104. The computing device 100 can present a fact sheet user interface which displays detailed information for one or more selected customer accounts in response to receiving user input selecting a fact sheet user interface element 106. If the map view user interface or the fact sheet user interface is being displayed, the computing device 100 can present the relationship view user interface 102 in response to receiving user input selecting a relationship view user interface element 108.

The computing device 100 can display, in the relationship view user interface 102, a group of user interface elements which each represent of one or more customer accounts. For example, a user interface element can be a circle. As described in more detail below, user interface elements may be selectable by the user. For example, a user interface element 110 represents a single customer account and is a selected user interface element. As another example, a user interface element 112 represents a single, different customer account and is an unselected user interface element. A selected status of the user interface element 110 can be indicated by the additional border around the user interface element 110, as compared to the user interface element 112.

Some user interface elements can represent multiple customer accounts. For example, a user interface element 114 represents multiple customer accounts (e.g., 8 separate customer accounts, as indicated by an 8 inside of the circle) and is an unselected user interface element. A user interface element 116 represents multiple (e.g., 12) customer accounts and is a selected user interface element, as indicated by the additional border around the user interface element 116, as compared to the user interface element 114. In some implementations, the user interface elements 114 and 116 are referred to as “stacked” or “clustered” user interface elements, due to such user interface elements representing multiple customer accounts. Stacked user interface elements are described in more detail below.

The computing device 100 can display a user interface element according to characteristic values of customer account(s) that are associated with the user interface element. For example, user interface elements can be displayed on a graph 118. The graph 118 can include multiple user interface elements that represent multiple customer accounts and that are vertically positioned on the graph 118 in accordance with first values for a first characteristic and that are horizontally positioned on the graph 118 in accordance with second values for a second characteristic. The first and second characteristics can be, for example numeric characteristics. For example, the first characteristic can be gross sales and the second characteristic can be margin. The first and second values can correspond, for example, to a particular time period, such as a most recently completed quarter (e.g., as indicated by a user interface element 119).

Accordingly, user interface elements can be positioned on the graph 118 according to respective values for associated account(s) for gross sales and margin. For example, the user interface element 112 is positioned on the graph 118 according to a gross sales value of approximately 550,000 and a margin of approximately 15,000 for the associated customer account. As another example, the user interface element 114 is positioned on the graph 118 according to a gross sales value of approximately 375,000 and a margin of approximately 30,000.

As mentioned, some user interface elements (e.g., the “stacked” user interface elements 114 and 116) can represent multiple user accounts. The computing device 100 can associate multiple customer accounts with a single stacked user interface element in response to identifying multiple customer accounts for which the first value for the first characteristic and the second value for the second characteristic for each of the multiple customer accounts are similar in value. The computing device 100 can present a single, stacked user interface element to represent the combination of the multiple customer accounts. For example, as mentioned, twelve customer accounts are associated with the user interface element 116 and each of the twelve customer accounts have a gross sales value of approximately 325,000 and a margin of approximately 80,000. As described in more detail below, as the user zooms in or zooms out a user interface (e.g., the relationship view user interface 102 or a map view user interface), a stacked or unstacked state of one or more user interface elements may change.

Axes of the graph 118 can correspond to the first and second characteristics. For example, a vertical axis 120 can correspond to the first characteristic of gross sales and a horizontal axis 122 can correspond to the second characteristic of margin. A user interface element 124 can serve as a label for the vertical axis 120 and can also be selected to change the first characteristic. For example, the computing device 100 can, in response to receiving user input selecting the user interface 124, present a pop-up user interface from which a user can select a characteristic as the first characteristic. Another user interface element (not shown) can serve as a label for the horizontal axis 122 and can be selected to change the second characteristic.

In some implementations, the computing device 100 includes an indication of a third value for a third characteristic of one or more customer accounts when presenting a user interface element that represents the one or more customer accounts. For example, the computing device 100 can present a user interface element using a color which represents the third characteristic. The third characteristic can be, for example, an enumerated characteristic such as relationship activity. Different colors can correspond to different relationship activity values from the enumerated list. For example, colors of red, yellow, white, blue, and green can correspond to relationship activity values of very-low, low, medium, high, and very-high, respectively. The user interface elements 112 and 114 can be presented in a first color (e.g., red) and a second color (e.g., yellow), respectively, indicating, for example, that the customer accounts associated with the user interface elements 112 and 114 have values of very-low and low for the relationship activity characteristic, respectively.

In some implementations, the user can change the third characteristic. For example, a user interface element 125 can indicate a currently selected characteristic and the computing device 100 can receive user input selecting the user interface element 125. The computing device 100 can present, for example, a pop-up interface and can receive user input selecting a new third characteristic.

In some implementations, the computing device 100 can present stacked user interface elements which include an indication of the third value for the third characteristic for each of multiple customer accounts which are associated with the stacked user interface element. For example, as indicated by a note 126 and by the user interface element 116, counts of four, three, two, two, and one customer accounts have relationship activity levels of very-low, low, very-high, medium, and high, respectively. The indications of relationship activity levels are illustrated by first, second, third, fourth, and fifth colors of first, second, third, fourth, and fifth portions of the user interface element 116.

The computing device 100 can display, within the display of the graph 118, one or more visual features that visually separate the user interface elements presented in the graph 118 into quadrants. For example, the visual features can be lines that meet at a right angle. For instance, a horizontal line 128 and a vertical line 130 separate the graph 118 into quadrants 132, 134, 136, and 138.

The visual features can, for example, identify mean values for the first and second characteristics. For example, a mean value 140 for gross sales of 218,513 and a mean value 142 for margin of 60,484 for customer accounts represented by the user interfaces elements included in the graph 118 can be represented by the intersection of the horizontal line 128 and the vertical line 130. In some implementations, the visual features can identify other values, such as median values.

Separating the graph 118 into quadrants can allow the user to easily identify customer accounts that have certain characteristic patterns. For example, customer accounts that are associated with user elements included in the quadrant 132 (e.g., accounts associated with a user interface element 144) have lower than average gross sales values and lower than average margin values. As another example, customer accounts that are associated with user elements included in the quadrant 134 (e.g., the account associated with the user interface element 112) have higher than average gross sales values but have lower than average margin values. Similarly, customer accounts that are associated with user interface elements included in the quadrant 136 (e.g., the customer account associated with the user interface element 110) have higher than average gross sales values and higher than average margin values and customer accounts that are associated with user interface elements include in the quadrant 138 have higher than average margin values but lower than average gross sales values.

In some implementations, the user can move one or both of the visual elements to change the size of two or more quadrants. For example, the computing device 100 can receive user input selecting and moving the horizontal line 128 and/or user input selecting and moving the vertical line 130. As another example, the computing device 100 can receive user input selecting and moving a user interface element 146. For example, the user select and drag the user interface element 146 to a new location. The computing device 100 can, in response to such an input, present the user interface element 146 at the new location and can change the locations of the vertical line 130 and the horizontal line 128 so that the vertical line 130 and the horizontal line 128 intersect at the new location. In some implementations, the user interface element 146 includes an indicator 148 which indicates that the user interface element 146 is positioned at a location corresponding to the mean values for the first and second characteristics. If the user moves the user interface element 146 to some other position or otherwise provides a user input causing the user interface element 146 or the horizontal line 128 and/or the vertical line 130 to move, the computing device 100 can present the user interface element 146 without the indicator 148.

The computing device 100 can receive user input that interacts with the displayed graph to select a subset of the displayed user interface elements. In response to such user input, the computing device 100 can present the selected user interface elements in a different manner than unselected user interface elements. For example, as mentioned above, the user can select an individual user interface element, such as by tapping on a display of the user interface element. The user can also, for example, tap a selected user interface element to deselect the user interface element. The computing device 100 can receive multiple user inputs selecting multiple user interface elements, such as in response to the user tapping on each of the multiple user interface elements. As mentioned above, selected user interface elements can be presented by the computing device 100 as being selected due by the inclusion of an additional border.

As another example of selecting a subset of user interface elements, the computing device 100 can select all user interface elements that are located in a particular quadrant based on receiving user input of a quadrant selector user interface element. For example, the user interface element 146 can include four quadrant selector user interface elements, including a quadrant selector user interface element 150 associated with the quadrant 136, where each quadrant selector user interface element occupies a portion of the user interface element 146. The computing device 100 can present the user interface elements 110 and 116 and all other user interface elements included in the quadrant 136 (e.g., user interface elements 152, 154, 156, 158, and 160) in a selected state in response to receiving user input selecting the quadrant selector user interface element 150.

In response to selection of the quadrant selector user interface element 150, the computing device 100 can present the quadrant selector user interface element 150 in a style that is different than a style used for other, unselected quadrant selector user interface elements. For example, the computing device 100 can present the quadrant selector user interface element 150 in a black color which is different than a white color used for the other quadrant selector user interface elements. In some implementations, the computing device 100 presents the selected quadrant selector user interface element 150 in a different style for a predetermined amount of time after selection (e.g., one second), and presents the quadrant selector user interface element 150 in the same style as the other quadrant selector user interface elements after the predetermined amount of time elapses.

In some implementations, for a stacked user interface element, such as the user interface element 116, the user can select a subset of the portions of the stacked user interface element. For example, as shown in the note 126, the user can select a first portion 170 (e.g., corresponding to customer accounts having a low customer activity characteristic value) and a second portion 172 (e.g., corresponding to customer accounts having a very high customer activity level), from the five portions included in the user interface element 116. The selected portions can be distinguished from unselected portions. For example, as shown, the selected portions can have a different (e.g., thicker, different colored) border. As another example, selected portions can be displayed in a brighter color, as compared to unselected portions which may be shown in a more muted color.

As mentioned, data for characteristic values may correspond to a particular time period, such as a most recently completed quarter. The computing device 100, in response to receiving user input selecting the user interface element 119, can present a user interface (e.g., a pop-up) which enables the user to select a different time period (e.g., a different quarter or a different interval, such as monthly or annually). In response to receiving user input specifying a different time period or interval, the computing device 100 can present the customer account user interface elements included in the graph 118 in a manner that corresponds to first, second and third characteristic values that are relevant for the specified time period or interval. As described in more detail below, the user can select a user interface element 162 to view how customer account characteristics change over time.

FIG. 2A shows a computing device 200 presenting user interface elements associated with a first time period. Similar to the computing device 100 described above with respect to FIG. 1, the computing device 200 displays, in a user interface 201, a graph 202 that includes user interface elements (e.g., including a user interface element 204) that illustrate differences between characteristics of customer accounts represented by the user interface elements included in the graph 202. The computing device 250 can display the user interface 201, for example, in response to receiving user input selecting a user interface element 205 (interface element 162 in FIG. 1).

In some implementations, characteristic values represented by the vertical and horizontal positioning of the user interface elements included in the graph 202 are time period specific. For example, a particular time period interval (e.g., quarterly, monthly, weekly, annually) and a particular time period of that interval length (e.g., a particular historical quarter) may be in effect. For example, as illustrated by a user interface element 206, a time period interval in effect may be a quarterly interval. As illustrated by a slider 208 positioned on a timeline 210, a particular quarter in effect may be the fourth quarter of the year 2011.

The computing device 200 can place user interface elements representing customer accounts in the graph 202 according to first values for a first characteristic (e.g., gross sales values) and second values for a second characteristic (e.g., margin) where the first values and the second values correspond to the time period interval and particular time period in effect. For example, the computing device 200 can identify or determine such first and second values and/or can request such first and second values from another computing system. As a particular example, the computing device 200 can identify, determine, or receive, for the customer account associated with the user interface element 204, a gross sales value and a margin value, for the fourth quarter of 2011 (e.g., in accordance with the location of the slider 208 on the timeline 210). In some implementations, the computing device 200 is configured so that user interface elements included in the graph 202 are not shown in a “stacked” manner when the timeline 210 is displayed, even if the user interface elements have similar values.

The computing device 200 can place visual elements (e.g., a vertical line 212 and a horizontal line 214) according to the time period interval and particular time period in effect. For example, the vertical line 212 and the horizontal line 214 can be placed according to a mean value (or some other metric, such as a median value) of the second characteristic and the first characteristic, respectively, for the time period in effect for the customer accounts associated with the user interface elements included in the graph 202. Placement of the vertical line 212 and the horizontal line 214 can divide the graph 202 into quadrants, as described above.

The user interface 201 can enable the user to change the effective time period. For example, the user can select the slider 208 and drag the slider 208 to a new location on the timeline 210 to enact a change in the effective time period. Such a user input can cause the computing device 200 to change the displayed location of the user interface elements included in the graph 202, the vertical line 212, and the horizontal line 214.

For example, FIG. 2B shows a computing device 250 displaying a user interface 251 including a graph 252, a slider 254, and a timeline 256, where the computing device 250, the user interface 251, the graph 252, the slider 254, and the timeline 256 respectively correspond to the computing device 200, the user interface 201, the graph 202, the slider 208, and the timeline 210 of FIG. 2A. As shown in FIG. 2B, the user has moved the slider 254 to a different location on the timeline 256, as compared to the location of the slider 208 on the timeline 210 as shown in FIG. 2A. Specifically, the slider 254 is positioned on a location representing the fourth quarter of 2010.

Accordingly, the computing device 250 can set a new effective time period to be the fourth quarter of 2010 and can move the user interface elements included in the graph 252 to positions on the graph 252 that correspond to gross sales values and margin values that are associated with the new effective time period and with the customer accounts that are associated with the user interface elements. For example, the computing device 250 can place a user interface element 258 (e.g., corresponding to the user interface element 204 of FIG. 2A) in a location that corresponds to a gross sales value and a margin value for the customer account associated with the user interface element 258 where the gross sales value and the margin value are identified or derived from data corresponding to the new effective time period. The computing device 250 can also place a vertical line 260 and a horizontal line 262 according to a mean gross sales value and a mean margin value, respectively, for the new effective time period for the customer accounts associated with the user interface elements included in the graph 252.

In some implementations, the computing device 250 causes the user interface elements included in the graph 252, the vertical line 260, and the horizontal line 262 to move in real time while the user moves the slider 254 along the timeline 256. That is, the user interface elements included in the graph 252, the vertical line 260, and the horizontal line 262 can be placed, as the slider 254 is moved, according to intermediate time period values that are between a starting position and an ending position of a movement of the slider 254 along the timeline 256. For example, as the user moves the slider from a position on the timeline 256 representing the fourth quarter of 2011 to a displayed position of the slider 254 which represents the fourth quarter of 2010, the computing device 250 can display the user interface elements included in the graph 252, the vertical line 260, and the horizontal line 262, in turn, according to data associated with the third, second, and first quarters of 2011, before displaying the graph according to the ending position of the fourth quarter of 2010.

Similar to the relationship view user interface 102 described above with respect to FIG. 1, the user can select a subset of the user interface elements included in the graph 252, such as by individually selecting one or more user interface elements or by selecting a quadrant of user interface elements using a quadrant selector included in a user interface element 264. Once a user has selected a group of customer account user interface elements, the user may save the group or perform some other action with the group. For example, the user may select a save user interface element 266 to save the group and may provide user input to name the group.

In response to user input selecting the user interface element 266, the computing device 250 or another computing system may store information that identifies that the customer accounts that are associated with the selected user interface elements are assigned to the group. At some later point in time, the user or another user may provide input requesting to view user interface elements that are assigned to the group. The user can save a group of user interface elements as a group in other user interfaces, such as the relationship view user interface 102 described above with respect to FIG. 1 or a map view user interface.

The user or another user may request that an action be performed with a saved group, such as providing user input to view a saved group using a map or to include information associated with customer accounts included in the group in a document, such as an email message. For example, in response to user input selecting a user interface element 268, the computing device 250 can present a user interface for composing an email message which includes customer account information.

FIG. 3 shows a computing device 300. In response to selection of a user interface element (e.g., the user interface element 268 previously discussed with respect to FIG. 2B), the computing device 300 can display a composition user interface 302 in which the user can compose an email. The computing device 300 can automatically insert information that identifies the customer accounts that are assigned to a group of user interface elements, where the group of user interface elements can be, for example, a saved group or a group of user interface elements currently selected on a user interface (e.g., a relationship view or map view user interface). For example, the computing device 300 can insert customer names 304 and customer identifiers 306 into the composition user interface 302.

In some implementations, the computing device 300 can present a customer account information selection user interface (not shown) in which the user can select one or more types of customer account information to insert into the composition user interface 302. For example, the customer account information selection user interface can enable the user to select one or more customer account characteristics. The computing device 300 can insert a corresponding value for each selected type of customer account information for each customer account that is assigned to the selected user interface elements.

A virtual keyboard 308 can enable the user to draft a message 310 to be included with the inserted customer account information (e.g., to be included with the customer names 304 and the customer identifiers 306). A cancel user interface element 312 can enable the user to cancel the composing of an email. A send user interface element 314 can enable the user to send an email to another user (e.g., the other user can be identified using a recipient field (not shown). For example, in response to receiving selection of the send user interface element 314, the computing device 300 can generate an email message that includes the message 310, the customer names 304, and the customer identifiers 306, and send the generated email message to the other user.

FIG. 4 shows a computing device 400. The computing device 400 is displaying an example map view user interface 402. The computing device 400 can display the map view user interface 402, for example, in response to receiving a user input selecting a map view user interface element 404.

The map view user interface 402 includes a map of the United States. User interface elements which represent customer accounts are located at various locations on the map. For example, each user interface element can be located at a map location which corresponds to a place of business associated with one or more customer accounts. For example, a user interface element 406 may correspond to a customer account of a customer located in Arizona. As another example, the user interface element 408 may correspond to three customer accounts of customers that are located in or near Chicago.

Different groups of user interface elements can be displayed in the map view user interface 402. For example, a group of user interface elements displayed in the map view user interface 402 can represent the same set of customer accounts that are displayed in another user interface (e.g., the relationship view user interface 102 described above with respect to FIG. 1) when user selection of a map view user interface element (e.g., the map view user interface element 104 described above with respect to FIG. 1) is received.

As another example, the computing device 400 may display, in the map view user interface 402, a group of user interface elements that correspond to a group of customer accounts included in a previously-saved group of customer accounts. For example, the computing device 400 can receive a first user input selecting a groups user interface element 410 and a second user input selecting a particular group. For example, the computing device 400 can receive user input indicating selection of a “Product Rollout” group. In response to such a selection, the computing device 400 can display on the map a set of user interface elements corresponding to the selected group. As illustrated by a title 412, the computing device 400 can display a name of the selected group (e.g., “Product Rollout”) and an indication of the number of customer accounts included in the selected group (e.g., twenty six). In some implementations, the computing device 400 displays a list 414 of customer accounts included in the selected group.

As illustrated by the user interface element 408, a single user interface element can represent multiple customer accounts, such as if multiple customer accounts are located in a same or similar area on the map. The user can zoom the map, such as by using a zoom-in user interface element 416 and/or a zoom-out user interface element 418, or by using pinch finger gestures or spread finger gestures on the touchscreen display. As the user zooms, the number and type of user interface elements displayed on the map can change. For example, in response to user input selecting the zoom-in control 416, the computing device 400 can replace the map with a zoomed-in map and can replace the user interface element 408 with three individual user interface elements, such as if the zoomed-in map is displaying the Chicago area in more detail than the previously displayed map. As another example, in response to user input selecting the zoom-out control 418, the computing device 400 can replace the map with a zoomed-out map and can replace the user interface element 406 and a user interface element 420 with a single user interface element, where the single user interface element includes an indication (e.g., a number “2”), which indicates that the single user interface element represents two customer accounts.

FIG. 5 shows a computing device 500 which is displaying a map view user interface 502. The user can select a user interface element presented on the map view user interface 502. For example, the user can select a user interface element 504 which represents two customer accounts and/or can select a user interface element 506 which represents one customer account. For example, the computing device 500 can receive a first type of user input that contacts a portion of the map view user interface 502 at which the user interface element 504 is being displayed. For example, the first type of user input can be a tap. In response to such an input, the computing device 500 can add the selected user interface element to a group of selected user interface elements.

As another example, the computing device 500 can receive a second type of user input that contacts a portion of the map view user interface 502 at which the user interface 504 is being displayed. For example, the second type of user input can be a tap and hold. In response to such a user input, the computing device 500 can add a display of information that is associated with the customer accounts that are associated with the user interface element 504 to the map view user interface 502 and can present the display of information in a first style.

For example, the computing device 500 can display a pop-up 508 which includes a first item 510 associated with a “Beethoven Beavers” customer account and a second item 512 associated with a “Snider's Construction” customer account. Each of the first item 510 and the second item 512 displays a summarized list of information for the respective associated customer account. In some implementations, the pop-up 508 is referred to as a “customer quick view”. In response to receiving the second type of user input selecting the user interface element 506, a pop-up can be displayed which includes information for the customer account that is associated with the user interface element 506.

As another yet another example of a selection user input, the computing device 500 can receive a third type of user input. For example, the user can provide user input that contacts an item included in the pop-up 508. In response to such an input, the computing device 500 can add a display of information to the map view user interface 502 for a customer account associated with the selected item and can present the display of information in a second style. For example, the second style can be a display of information that is more comprehensive than information that is displayed in the pop-up 508. For instance, in response to receiving user input selecting the first item 510, the computing device 500 can add a side bar 512 to the map view user interface 502. The side bar 512 includes information for the “Beethoven Beavers” customer account that is associated with the first item 510. For example, the side bar 512 presents a first characteristic value 514 (e.g., a value of “Occasional” for an “Activity” characteristic) and a second characteristic value 516 (e.g., a value of “Satisfied” for a “Satisfaction” characteristic).

In some implementations, a fourth type of user input can be received For example, the computing device 500 can receive user input associated with the user interface element 502 that is distinguishable from the first type of user input (e.g., the first type of user input can be a tap and the fourth type of user input can be a double tap). In response to receiving such a user input in association with the user interface element 506, the computing device 500 can display information associated with the customer account that is associated with the user interface element 506 in the side bar 512.

Information displays such as the pop-up 508 and the side bar 512 can be displayed in other types of user interfaces, such as the relationship view user interface 102 described above with respect to FIG. 1. For example, the computing device 100 can receive a first type of user input, such as a tap and hold on a particular user interface element included in the graph 110. A display of information that is associated with the customer account that is associated with the selected user interface element can be displayed, where the display of information can be similar to the pop-up 508 of FIG. 5.

As another example, the computing device 100 can receive a second type of user input associated with a particular user interface element included in the graph 118 which causes the computing device 100 to present an information display similar to the side bar 512, such as an information display which displays comprehensive information for one or more customer accounts associated with the particular user interface element. For example, the computing device 100 can display an information display similar to the side bar 512 in response to a double tap on a user interface element included in the graph 118 or in response to a tap of an item corresponding to a customer account that is included in a pop-up interface.

FIG. 6 is a flow chart of a process 600 for displaying customer account information. The process 600 may be performed by the computing device(s) that are described with respect to FIGS. 1-5 and may provide information for generating the user interfaces of FIGS. 1-5.

In box 602, a computing system identifies multiple customer accounts for which to display a graph that illustrates differences between characteristics of the multiple customer accounts, where each of the multiple customer accounts is associated with a first value for a first characteristic of the multiple customer accounts and a second value for a second characteristic of the multiple customer accounts. For example, the computing device 100 may identify a group of customer accounts, such as a group assigned by a user of a CRM or ERP system or by the CRM or ERP system.

In box 604, the computing system presents a display of the graph that illustrates the differences between the characteristics of the multiple customer accounts, where the displayed graph includes multiple user interface elements (e.g., circles) that represent the multiple customer accounts and that are vertically positioned on the graph in accordance with the first values, and that are horizontally positioned on the graph in accordance with the second values. For example, the computing device 100 can display the graph 118 which includes, among other user interface elements, the user interface element 112.

For example, in box 606, the computing system displays, within the display of the graph that illustrates the differences between the characteristics of the multiple customer accounts, one or more visual features that visually separate the multiple user interface elements that represent the multiple customer accounts into quadrants. For example, the one or more visual features may include a horizontal line which identifies a mean value for the first value for the multiple customer accounts and a vertical line which identifies a mean value for the second value for the multiple customer accounts. The one or more visual features may include horizontal line 128 and vertical line 130.

As another example, in box 608, the computing system presents a single interface element to represent a combination of customer accounts. For example, the computing system can identify at least two of the multiple customer accounts for which the first value for the first characteristic and the second value for the second characteristic for each of the at least two of the multiple customer accounts are similar in value. The computing system can present a single one of the multiple user interface elements to represent the combination of the at least two of the multiple customer accounts. For example, the computing device 100 can present the user interface 114 which is a representation of eight customer accounts.

In box 610, the computing system receives user input that interacts with the displayed graph. For example, the computing system can receive user input to select the user interface elements for a subset of the multiple customers. For example, in box 612, the computing system receives a first type of user input that contacts a portion of the display of the graph at which a particular one of the multiple user interface elements is being displayed. For example, the computing system can receive a tap user input on the particular user interface element. For example, the computing device 100 can receive user input selecting the user interface element 110.

As another example, in box 614, the computing system receives user input that interacts with the one or more visual features to select one of the quadrants. For example, the computing system can display a quadrant selector user interface element at the intersection of the vertical and horizontal lines which enables the user to indicate a particular quadrant for selection. For example, the computing system can receive user input selecting a portion of the quadrant selector user interface element that corresponds to a particular quadrant. For instance, the computing system can receive user input selecting the upper left portion of the quadrant selector user interface and can determine that the user input is a request to select the upper left quadrant. The computing device 100, for example, can receive user input selecting the quadrant selector 150.

As another example of receiving user input that interacts with the displayed graph, in box 616, the computing system receives user input that selects an interface element to change a displayed time. For example, each of the multiple customer accounts can be associated with multiple first values for multiple respective times and with multiple second values for the multiple respective times. The computing system can receive user input that selects an interface element to change a selected time of the multiple times from a first time to a second time. For example, the computing device 200 can receive user input moving the slider 208.

As yet another example, in box 618, the computing system receives different types of user input that contacts one of the multiple user interface elements. For example, the computing system can receive a first type of user input and a second type of user input, where each user input contacts a portion of the display of the graph at which one of the multiple user interface elements is being displayed. For example, the first type of input can be a double-tap and the second type of input can be a tap and hold. For example, the computing device 100 can receive a tap and hold input associated with the user interface element 110. As another example, the computing device 500 can receive a double tap user input associated with the user interface element 504.

In box 620, the computing system presents the selected user interface elements in a different manner than the indication for those of the multiple customers that have not been selected. For instance, in response to receiving a first type of user input that contacts a portion of the display of the graph at which a particular one of the multiple user interface elements is being displayed (e.g., box 612), the computing system can present the particular user interface element in a style which indicates that the particular user interface element is selected. For example, the computing system can apply a particular border or pattern to the particular user interface element. For example, the computing device 100 can present the selected user interface element 110 with an additional border as compared to the unselected user interface element 112. As another example, in response to receiving user selection of a quadrant, the computing system can apply a style to each of the user interface elements included in the quadrant to indicate that such user interface elements are selected. For example, in response to receiving user input selecting the quadrant selector 150, the computing device 100 can apply a border around each of the user interface elements included in the quadrant 136.

In response to receiving user input that selects a user interface element to change a displayed time from a first time to a second time (e.g., box 616), the computing system can cause a positioning of each of the multiple user interface elements to change from a positioning associated with the first value and second value for the first time to the first value and second value for the second time. For example, in response to receiving user input selecting the slider 254, the computing device 250 can present the user interface elements included in the graph 252 at locations that correspond to first values and second values associated with the time period represented by the new position of the slider 254.

As another example, in response to receiving the first type of user input (e.g., tap and hold) on a particular user interface element (e.g., box 618), the computing system can add a display of information that is associated with a customer account that is associated with the particular user interface element to appear in a first style of presentation. For example, the computing system can add a side-bar display which presents information for the customer account.

As yet another example, in response to receiving the second type of user input (e.g., double tap) on a particular user interface element (e.g., box 618), the computing system can add a display of a subset of the information that is associated with the customer account that is associated with the particular user interface element to appear in a second style of presentation. For example, the computing system can add a pop-up display which presents summarized information for the customer account, where the pop-up display is positioned in proximity to the particular user interface element. For instance, in response to receiving the second type of user input on the user interface element 504, the computing device 500 can present the pop-up 508.

Although FIGS. 1 to 5 display multiple, different computing devices, some or all of the multiple, different computing devices may be the same computing device. For example, computing device 200 may be computer device 100, but displaying a different user interface at a different time.

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high-speed controller 708 manages bandwidth-intensive operations for the computing device 700, while the low speed controller 712 manages lower bandwidth-intensive operations. Such allocation of functions is by way of example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, some of which are shown in the figure. For example, it may be implemented as a cellular telephone 780. It may also be implemented as part of a smartphone 782, personal digital assistant, or other similar mobile device.

Additionally computing device 700 or 750 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method, comprising:
identifying, by a computing system, multiple customer accounts for which to display a graph that illustrates differences between characteristics of the multiple customer accounts, wherein each of the multiple customer accounts is associated with a first value for a first characteristic of the multiple customer accounts and a second value for a second characteristic of the multiple customer accounts;
presenting, by the computing system, a display of the graph that illustrates the differences between the characteristics of the multiple customer accounts, the displayed graph including multiple user interface elements that represent the multiple customer accounts and that are vertically positioned on the graph in accordance with the first values, and that are horizontally positioned on the graph in accordance with the second values;
receiving, by the computing system, user input that interacts with the displayed graph to select the user interface elements for a subset of the multiple customers; and
presenting, by the computing system, the selected user interface elements in a different manner than the indication for those of the multiple customers that have not been selected.

2. The computer-implemented method of claim 1, wherein:
presenting the display of the graph includes presenting the display of the graph on a touchscreen display; and
receiving the user input that interacts with the displayed graph includes receiving an indication of user input that contacted portions of the graph at which the user interface elements for the subset of the multiple customers were displayed.

3. The computer-implemented method of claim 1, further comprising:
displaying, within the display of the graph that illustrates the differences between the characteristics of the multiple customer accounts, one or more visual features that visually separate the multiple user interface elements that represent the multiple customer accounts into quadrants.

4. The computer-implemented method of claim 3, wherein the one or more visual features identify a mean value for the first values for the multiple customer accounts and a mean value for the second values for the multiple customer accounts.

5. The computer-implemented method of claim 3, wherein receiving the user input that interacts with the displayed graph includes receiving user input that interacts with the one or more visual features to select one of the quadrants, selection of the quadrant resulting in the computing system selecting each of the multiple user interface elements that are displayed as being within the one of the quadrants without user selection of any of the multiple user interface elements within the one of the quadrants individually.

6. The computer-implemented method of claim 1, wherein each of the multiple customer accounts is associated with multiple first values for multiple respective times, and is associated with multiple second values for the multiple respective times; and
further comprising receiving, by the computing system, user input that selects an interface element to change a selected time of the multiple times from a first time to a second time, and as a result causing a positioning of each of the multiple user interface elements to change from a positioning associated with the first value and the second value for the first time to the first value and the second value for the second time.

7. The computer-implemented method of claim 1, further comprising:
receiving, by the computing system, a first type of user input that contacts a portion of the display of the graph at which one of the multiple user interface elements is being displayed, and as a result adding a display of information that is associated with the customer account that is associated with the one of the multiple user interface elements to appear in a first style of presentation; and
receiving, by the computing system, a second type of user input that contacts a portion of the display of the graph at which the one of the multiple user interface elements is being displayed, and as a result adding a display of only a subset of the information that is associated with the customer account that is associated with the one of the multiple user interface elements to appear in a second style of presentation.

8. The computer-implemented method of claim 1, further comprising:
identifying, by the computing system, at least two of the multiple customer accounts for which the first value for the first characteristic and the second value for the second characteristic for each of the at least two of the multiple customer accounts are similar in value; and
presenting, by the computing system, a single one of the multiple user interface elements to represent the combination of the at least two of the multiple customer accounts.

9. The computer-implemented method of claim 8, further comprising:
receiving, by the computing system, user input that selects the presented single one of the multiple user interface elements, and as a result adding a concurrent display of information for each of the at least two of the multiple customer accounts.

10. The computer-implemented method of claim 8, wherein:
each of the at least two of the multiple customer accounts is associated with a third value for a third characteristic; and
the presented single one of the multiple user interface elements includes an indication of the third value for the third characteristic for each of the at least two of the multiple customer accounts, such that a viewer of the presented display of the graph is able to identify the third value for each of the at least two of the multiple customer accounts by viewing only the presented single one of the multiple user interface elements.

11. One or more computer-readable medium including instructions therein that, when executed by one or more computer processors, causes performance of operations that include:
identifying, by a computing system, multiple customer accounts for which to display a graph that illustrates differences between characteristics of the multiple customer accounts, wherein each of the multiple customer accounts is associated with a first value for a first characteristic of the multiple customer accounts and a second value for a second characteristic of the multiple customer accounts;
presenting, by the computing system, a display of the graph that illustrates the differences between the characteristics of the multiple customer accounts, the displayed graph including multiple user interface elements that represent the multiple customer accounts and that are vertically positioned on the graph in accordance with the first values, and that are horizontally positioned on the graph in accordance with the second values;
receiving, by the computing system, user input that interacts with the displayed graph to select the user interface elements for a subset of the multiple customers; and
presenting, by the computing system, the selected user interface elements in a different manner than the indication for those of the multiple customers that have not been selected.

12. The one or more computer-readable medium of claim 11, wherein:
presenting the display of the graph includes presenting the display of the graph on a touchscreen display; and
receiving the user input that interacts with the displayed graph includes receiving an indication of user input that contacted portions of the graph at which the user interface elements for the subset of the multiple customers were displayed.

13. The one or more computer-readable medium of claim 11, wherein the operations further comprise:
displaying, within the display of the graph that illustrates the differences between the characteristics of the multiple customer accounts, one or more visual features that visually separate the multiple user interface elements that represent the multiple customer accounts into quadrants.

14. The one or more computer-readable medium of claim 13, wherein the one or more visual features identify a mean value for the first values for the multiple customer accounts and a mean value for the second values for the multiple customer accounts.

15. The one or more computer-readable medium of claim 13, wherein receiving the user input that interacts with the displayed graph includes receiving user input that interacts with the one or more visual features to select one of the quadrants, selection of the quadrant resulting in the computing system selecting each of the multiple user interface elements that are displayed as being within the one of the quadrants without user selection of any of the multiple user interface elements within the one of the quadrants individually.

16. The one or more computer-readable medium of claim 11, wherein each of the multiple customer accounts is associated with multiple first values for multiple respective times, and is associated with multiple second values for the multiple respective times; and
wherein the operations further comprise receiving, by the computing system, user input that selects an interface element to change a selected time of the multiple times from a first time to a second time, and as a result causing a positioning of each of the multiple user interface elements to change from a positioning associated with the first value and the second value for the first time to the first value and the second value for the second time.

17. The one or more computer-readable medium of claim 11, wherein the operations further comprise:
receiving, by the computing system, a first type of user input that contacts a portion of the display of the graph at which one of the multiple user interface elements is being displayed, and as a result adding a display of information that is associated with the customer account that is associated with the one of the multiple user interface elements to appear in a first style of presentation; and
receiving, by the computing system, a second type of user input that contacts a portion of the display of the graph at which the one of the multiple user interface elements is being displayed, and as a result adding a display of only a subset of the information that is associated with the customer account that is associated with the one of the multiple user interface elements to appear in a second style of presentation.

18. The one or more computer-readable medium of claim 11, wherein the operations further comprise:
identifying, by the computing system, at least two of the multiple customer accounts for which the first value for the first characteristic and the second value for the second characteristic for each of the at least two of the multiple customer accounts are similar in value; and
presenting, by the computing system, a single one of the multiple user interface elements to represent the combination of the at least two of the multiple customer accounts.

19. The one or more computer-readable medium of claim 18, wherein the operations further comprise:
receiving, by the computing system, user input that selects the presented single one of the multiple user interface elements, and as a result adding a concurrent display of information for each of the at least two of the multiple customer accounts.

20. The one or more computer-readable medium of claim 18, wherein:
each of the at least two of the multiple customer accounts is associated with a third value for a third characteristic; and
the presented single one of the multiple user interface elements includes an indication of the third value for the third characteristic for each of the at least two of the multiple customer accounts, such that a viewer of the presented display of the graph is able to identify the third value for each of the at least two of the multiple customer accounts by viewing only the presented single one of the multiple user interface elements.
